(19) United States
(12) Patent Application Publication
(10) Pub. No.: US 2017/0343239 A1
(43) Pub. Date: Nov. 30, 2017

(54) AIR CONDITIONING UNIT

(71) Applicant: Anthony J. Zunino, Landenberg, PA (US)

(72) Inventor: Anthony J. Zunino, JR., Landenberg, PA (US)

(21) Appl. No.: 15/600,881

(22) Filed: May 22, 2017

Related U.S. Application Data
(60) Provisional application No. 62/341,666, filed on May 26, 2016.

(51) Int. Cl. F24F 13/20; F24F 11/00; G05D 23/19; F24F 12/00; F24F 3/14; F24F 1/00

(52) U.S. Cl. CPC F24F 13/20; F24F 11/0076; F25B 2600/02; F24F 2013/205; F24F 1/0018; F24F 12/001; F24F 3/14; G05D 23/1928; F24F 2013/202

(57) ABSTRACT

An air conditioning unit includes a compressor, a condenser coil, a condenser outdoor fan, a metering/expansion device, an evaporator coil and an evaporator/indoor fan. The outdoor fan and the indoor fan are direct drive plenum fans controlled by variable frequency drives.

### CROSS REFERENCE TO RELATED APPLICATION

This application is based on provisional application Ser. No. 62/341,666, filed May 26, 2016, all of the details of which are incorporated herein by reference thereto.

### BACKGROUND OF INVENTION

Air conditioning units have been used for various purposes. Ideally an air conditioning unit should be efficient, compact, versatile, reliable and should also be cleanable and corrosive resistant. Air conditioning units have been used in various environments, such as in home use and also in industrial use, including industries such as tie mushroom growing industry where temperature control is critical.

### SUMMARY OF INVENTION

An object of this invention is to provide an air conditioning unit which has the above desirable characteristics.

In accordance with this invention the air conditioning unit comprises a frame which forms a plurality of compartments. The compartments are closed by panels and access doors to form a cabinet. The components within the various compartments include a compressor, a condenser coil, a condenser/outdoor fan, a metering device or expansion device, an evaporator coil and an evaporator/indoor fan. Preferably, the components also include variable frequency drives.

In a preferred practice of the invention, the indoor and outdoor fans are direct drive plenum fans. The variable frequency drives (VFD) control the operation of the plenum fans. The VFD's may also control the compressors.

The air conditioning unit could be used for various purposes, such as in the mushroom growing industry.

### THE DRAWINGS

FIG. 1 is a schematic front view of an air conditioning unit in accordance with this invention;

FIG. 1A is a front view of the air conditioning unit of

FIG. 1 with one of the panels removed;

FIG. 2 is a schematic rear view of the air conditioning unit of FIGS. 1-1A;

FIG. 3 is a schematic left side view of the air conditioning unit of FIGS. 1-2;

FIG. 3A is a schematic left side view of the air conditioning unit shown in FIG. 3 with some of the panels removed;

FIG. 4 is a schematic right view of the air conditioning unit of FIGS. 1-3;

FIG. 4A is a schematic right view of the air conditioning unit shown in FIG. 4 with some of the panels removed;

FIG. 5 is a side view of a preferred fan used in the air conditioning unit of FIGS. 1-4A;

FIG. 5A is a perspective view of the fan shown in FIG. 5; and

FIGS. 6-7 are schematic side views showing the air conditioning unit of FIGS. 1-5A as used with a mushroom house.

### DETAILED DESCRIPTION

The air conditioning unit of this invention generally comprises a frame which forms a plurality of compartments.

Various doors and panels close the compartments to form a cabinet. Each or all of the various doors and panels can be openable or removable for access to the components within the cabinet.

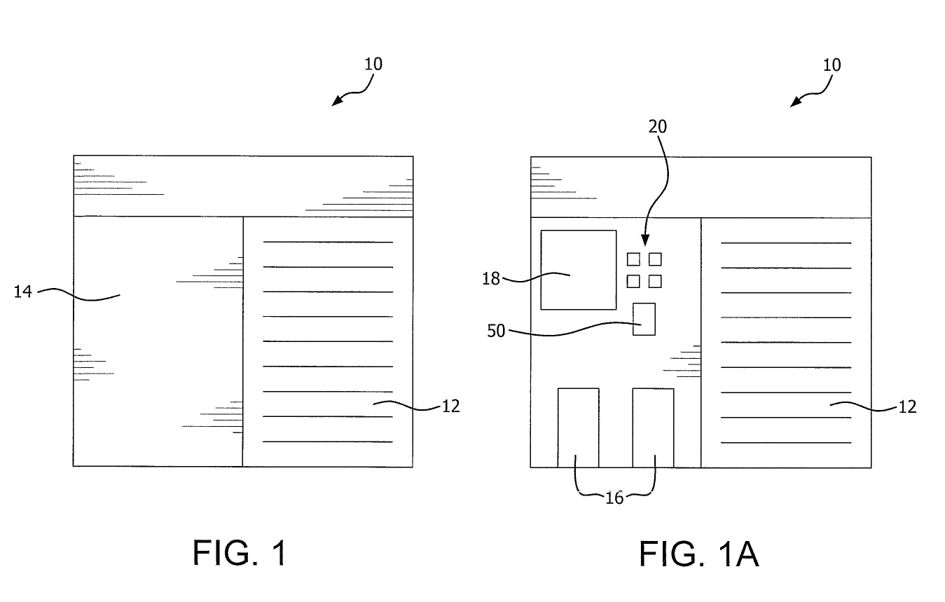

FIG. 1 illustrates an air conditioning unit 10 in accordance with this invention. As shown therein, one of the components in the cabinet is a condenser coil 12. A panel 14 or door closes the remaining portion of the front of the cabinet. FIG. 1A schematically illustrates the front of the cabinet where the panel 14 has been removed. In this figure the components of the compartment include compressors 16 and breaker panel or fuses 18, the variable frequency drives 20, and the miscellaneous components and controls 50.

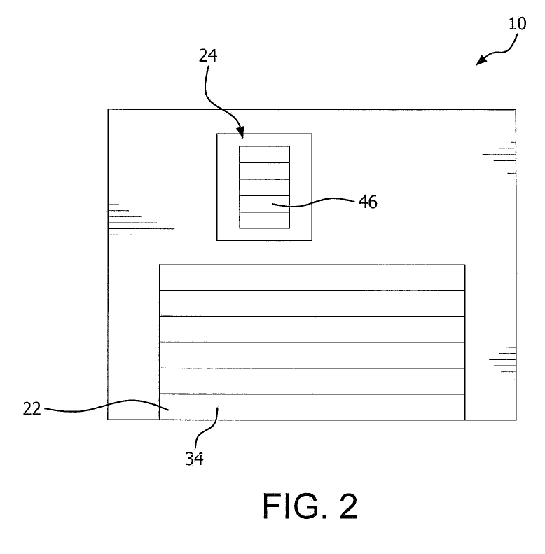

FIG. 2 shows the back or rear of the unit 10. The components visible from the backside include the evaporator coil 34, as well as supply air outlet or air discharge 24 and indoor fan 46. By providing suitable ducts at evaporator coil 34, there is a return air inlet; 22 by air traveling through the coil.

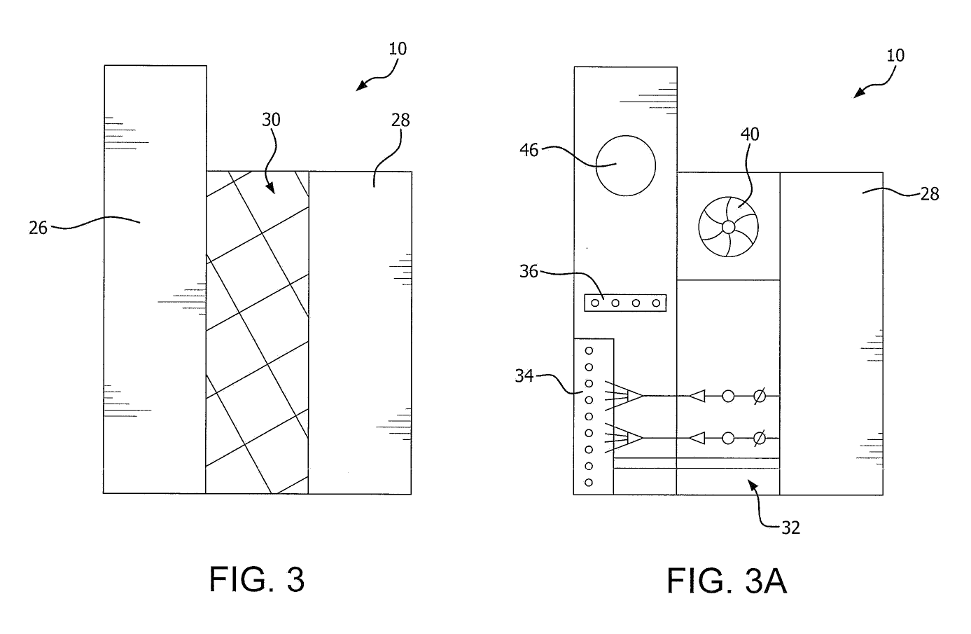

FIG. 3 schematically illustrates the left side of the unit 10. The outermost compartments are closed by panels or doors 26 and 28. The central compartment is covered by fan guard 30. FIG. 3A shows the left side of unit 10 with the panel 26 removed and with the fan guard 30 removed. Panel 28 is not normally removed. The removal of panel 26 and fan guard 30 exposes the refrigeration components, such as piping, driers, metering or expansion device, sight glasses, solenoid valves and other components which are generally indicated by the reference numeral 32. Other exposed components are evaporator coil 34, heat coil 36, indoor fan unit 46 and condenser (outdoor) fan discharge air unit 40.

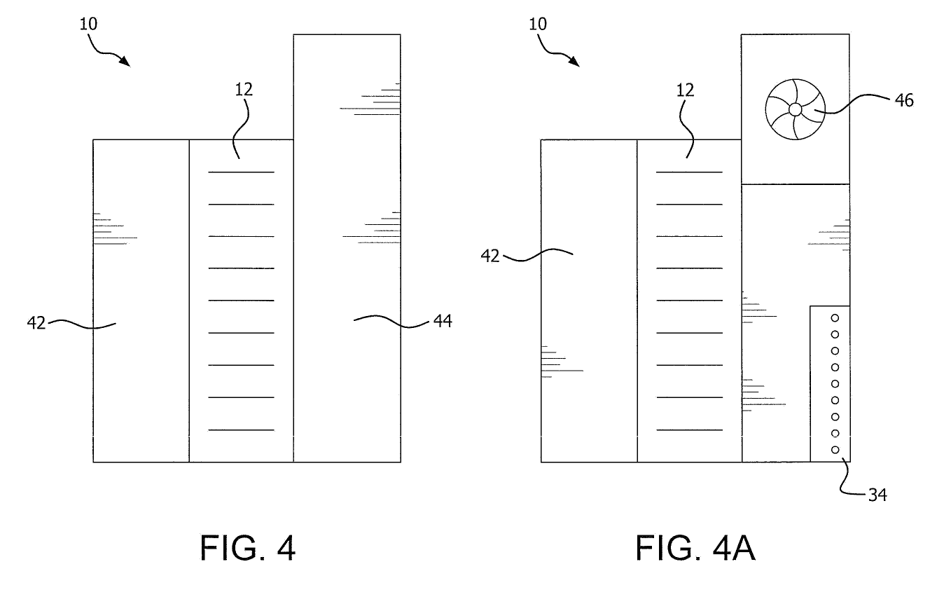

FIG. 4 schematically illustrates the right side view of unit 10. As shown therein panels or doors 42 and 44 close the outer compartments. Door 44 is preferably hinged. The condenser coil 12 is visible from the central area of the right side. FIG. 4A shows the right side of unit 10 with the panel or door 44 removed. This exposes the evaporator coil 34 and indoor fan unit 46. Panel 42 is normally not removed.

The components in unit 10 could vary in accordance with different tonnages. Each size unit would use one evaporator coil 34 and one evaporator or indoor fan 46. Smaller tonnage designs, such as 12 ton or 16 ton or 19 ton, would use one condensing coil 12, one compressor 16 and one condensing or outdoor fan 40. A medium tonnage design, such as 23 ton or 30 ton or 36 ton, would use two condensing coils 12 and two compressors 16 and one condensing or outdoor fan 40. Larger tonnage designs, such as 45 ton or 51 ton or 55 ton would use three condensing coils 12 and three compressors 16 and two condensing or outdoor fans 40. In these various units all accessible compartments are preferably hinged with latches. The electrical compartment has a lockable latch. There may be an additional top discharge on the condensing fan compartment.

With reference to FIG. 3 each of the doors or panels 26 and 28 and the fan guard 30 would be hinged with each having one latch. The electrical compartment would also have a lockable latch in the smaller and medium tonnage designs. A screened door or guard 30 would be provided for the condensing fan compartment. The smaller tonnage unit is illustrated in FIG. 4. Medium and larger tonnage units are illustrated in FIGS. 1 and 4. Where there are multiples of the same component, such as condensing coils, the components are placed next to each other. Thus, where there are multiple coils, the coils would be in the compartment closed by panel or door 42. All of the condensing coils are unrestricted from airflow and are only covered by a screened coil guard.

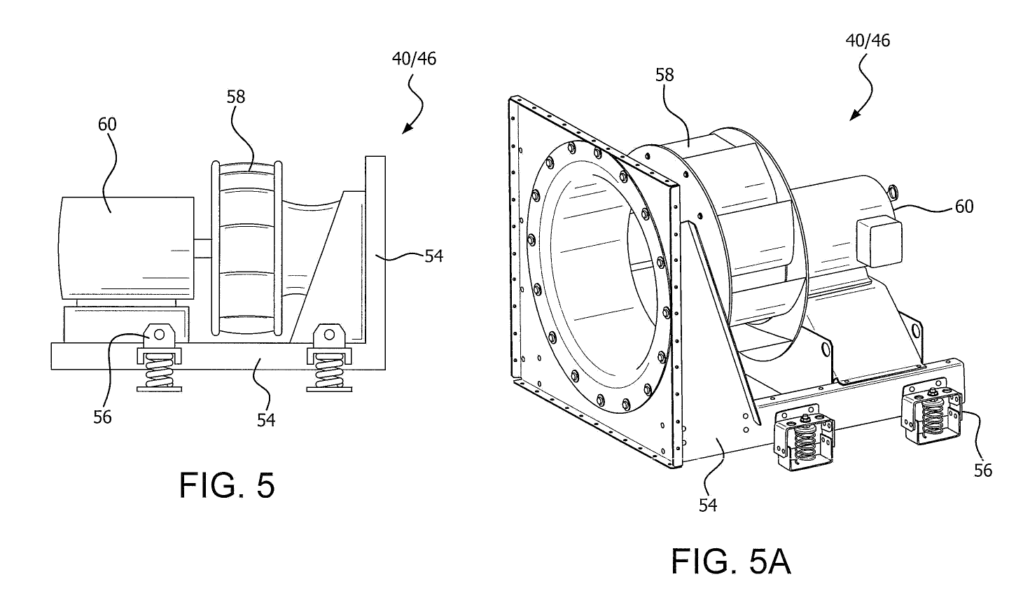

In the preferred practice of this invention outdoor fan 40 and indoor fan 46 are preferably plenum fans. In the practice of this invention such a plenum fan could be a Lau Corus Direct Drive Plenum Fan such as illustrated in FIGS. 5 and 5A. Such direct drive plenum fans are more efficient and offer more flexible ducting arrangements as compared to conventional fans. As shown in FIGS. 5 and 5A the fan 40/46 includes an increased torsional strength support 54 and has integral lifting points 56. The robotically welded energy efficient airfoil wheels 58 are driven by direct drive motor 60. Among the advantages of the direct drive plenum fans are space saving, reduced discharge sound levels and lower weight. In addition, air volume adjustments are made by the variable frequency drives and not by changing a drive kit. Such fans are commercially available from Lau of Dayton, Ohio.

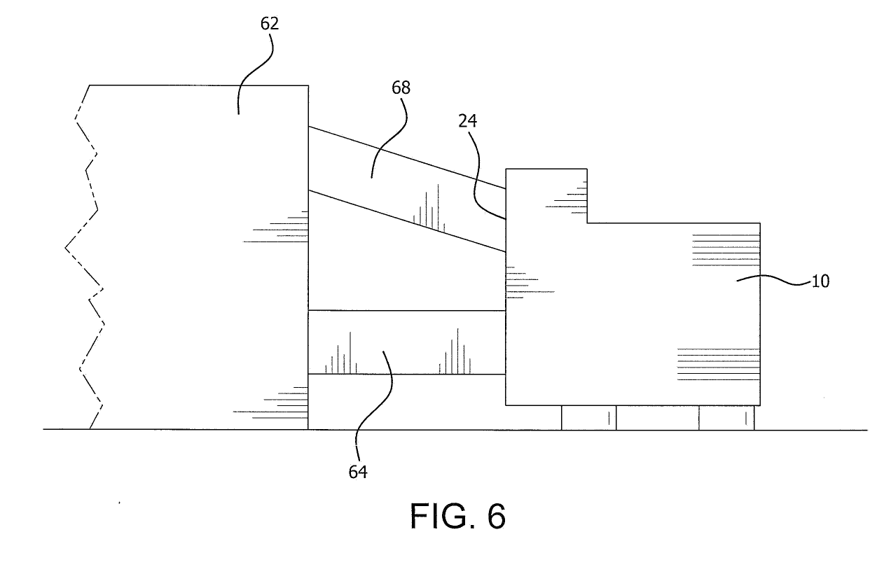

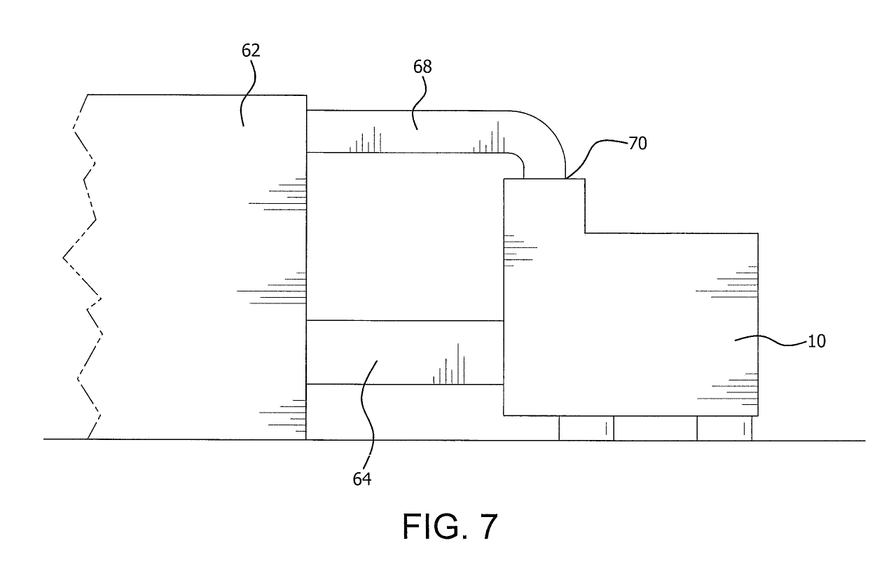

FIGS. 6-7 illustrate the use of unit 10 with a mushroom house 62. FIG. 7 illustrates unit 10 being used for horizontal discharge application. As shown therein, communication between unit 10 and mushroom house 62 is achieved through return air duct and/or air mixing box 64 with the horizontal air discharge 24 at the side of unit 10. FIG. 6 also illustrates the supply air duct 68.

FIG. 7 is similar to FIG. 6 except that there is a vertical air discharge application 70 at the top of unit 10.

The air conditioning unit 10 of this invention advantageously uses known components which include a number of critical and desirable/optional components. The critical components include a compressor, a condenser coil, condenser/outdoor fan, a metering device or expansion device, an evaporator coil, an evaporator/indoor fan. The fans 40,46 are plenum fans which are controlled by variable frequency drives (VFD) 20. The VFD may also control the compressors. Other possibilities include a heat coil, a dehumidification insulated motorized air damper and a dehumidification indoor condenser coil.

Given the teachings of this invention as to what components should be combined, a person of ordinary skill in the art would know how to combine those components.

The compressor 16 compresses refrigerant into high pressure vapor. Compressor speed is preferably varied by variable frequency drive and thermostat. The thermostat need not be packaged in the unit itself. The compressors can be controlled by the use of contactors as a less expensive and efficient option.

The condenser coil 12 comprises a series of tubing and aluminum fins where air is drawn through by condenser/outdoor fan 40 to cool and condense back to the liquid refrigerant.

The condenser/outdoor fan 40 which is preferably a direct drive plenum fan cools air through the condenser coil 12. The fan motor 60 is operated by the use of a variable frequency drive 20 and temperature or pressure transducer to vary the speed.

A metering device or expansion device meters the liquid refrigerant into the evaporator coil 34.

The evaporator coil 34 comprises a series of copper tubes and aluminum fins where air is drawn through by the indoor/evaporator fan 46 to vaporize metered refrigerant to a low pressure, thus causing the cooling effect. From here the low pressure vapor goes back to the compressor 16.

The evaporator/indoor fan 46 which is preferably a direct drive plenum fan pulls air through the evaporator coil 34. The fan motor 60 is operated by the use of a variable frequency and controller. The controller is not necessarily packaged as part of the unit cabinet. In this manner, the speed of the fan 46 can be varied.

The variable frequency drives 20 alter the frequency of the motors providing soft start control which lowers in rush current and improves efficiency. When used on properly selected compressors, capacity can be added to the unit. This system offers less short cycling which limits wear and tear and adds to efficiency also allowing more control of equipment when paired with the proper controller and/or thermostat.

An optional feature is a heat coil 36 which is preferably a hydronic heat coil located between the evaporator/indoor coil and fan. The heat coil 36 provides circulated hot water from any suitable source. The heating effect is created by pulling air through the coil.

A further option for unit 10 is a dehumidification insulated motorized air damper which would be located on a wall separating the condenser 12 and evaporator coil 34. This provides dehumidification by pulling heated air from the condenser compartment into the evaporator by the indoor fan 46 and opened air damper.

A further option for unit 10 is a dehumidification indoor condenser coil which would be located between the evaporator/indoor coil. If a hydronic heat coil is used the dehumidification coil would be located between the evaporator coil and the heat coil. The dehumidification indoor condenser coil provides dehumidification and harnesses heat from the compressor being used and also increases unit efficiency.

The unit 10 has a number of beneficial results. For example, unit 10 provides efficiency by saving energy. With the use of the direct drive plenum fans powered by the variable frequency drives for both the evaporator and condensing fan units, energy is saved. The evaporator (indoor fan) 46 is best used by being modulated according to CFMs needed for a BTU capacity to achieve maximum efficiency. This is done by sending a signal to the variable frequency drives from the properly selected controller or thermostat to change the frequency of the motor. The condensing (outdoor) fan unit 40 is controlled by the variable frequency drives 20 which is controlled by a signal given by an outdoor ambient temperature transducer or a refrigerant pressure transducer. The use of variable frequency drives (VFD) on compressors is also an efficiency booster although a control panel with the use of relays, contactors and end switches can be used as an alternative. A VFD can be used to alter the hertz of the compressor motor which like the fan motors 60, changes the speed which changes the flow of the refrigerant thereby changing the BTU capacity.

Unit 10 also provides reliability in that it is constructed with less moving but high quality parts. By using direct drive plenum fans the use of belts, pulleys and bearings is eliminated. Variable frequency drives (VFD) limit the use of relays, contactors, end switches and transformers. The breaker panel 52 with a breaker for each motor eliminates the use of fuse blocks, fuses or motor starters. Alternatively, fuse blocks could be used.

Unit 10 can also be constructed to be corrosive resistant by using materials which are noncorrosive or treated to be noncorrosive. The frame for the cabinet may, for example, be constructed of stainless steel square tubing. The panels which sheet the cabinet are preferably made with high density polyethylene or with stainless steel. The hardware is preferably stainless steel. The plenum fans 40 and 46 are preferably constructed of heavy aluminum. Coils, brazed joints and non-stainless steel metals in the airstream are preferably coated to be non-corrosive.

Unit 10 is readily cleanable by use of the removable or openable panels and doors which provide easy access to the coils for cleaning to optimize highest efficiency. The evaporator cabinet is easy to clean and sanitize to prevent diseases from developing in, for example, mushroom crop. There is also an easy access door to the evaporator compartment, and unit 10 includes easily removable panels. The high density polyethylene is easily cleaned, although other materials can be used.

Unit 10 is compact and versatile saving wharf space and is adaptable to new or existing duct work. Preferably the foot print or base area of unit 10 is made as small as possible and additional components can be included by adding height where needed. This is an important feature where wharf space is critical. The indoor air discharge can be vertical or horizontal as shown in FIGS. 6-7. The outdoor fan discharge can be horizontal or vertical.

A further option for unit 10 is to provide a motorized damper in the condenser area to provide heat and dehumidification to indoor air.

Although a particularly desirable use of unit 10 is in the mushroom farming industry, the invention is not limited to that use.

What is claimed is:

1. In an air conditioner unit comprising a cabinet, a compressor in said cabinet, a condenser coil in said cabinet, a condenser/outdoor fan in said cabinet, a metering/expansion device in said cabinet, an evaporator coil in said cabinet, and an evaporator/indoor fan in said cabinet; the improvement being in variable frequency drives in said cabinet for controlling said indoor fan and said outdoor fan, and each of said indoor fan and said outdoor fan being a direct drive plenum fan.

2. The unit of claim 1 wherein the speed of said compressor is controlled by said variable frequency drive and a thermostat.

3. The unit of claim 2 including a heat coil in said cabinet between said evaporator coil and said indoor fan.

4. The unit of claim 1 including a dehumidification insulated motorized air damper located between said condenser and said evaporator.

5. The unit of claim 1 including a dehumidification indoor condenser coil located between said evaporator and indoor coil.

6. The unit of claim 5 including a heat coil in said cabinet, and said dehumidification indoor condenser coil being located between said evaporator coil and said heat coil.

7. The unit of claim 1 wherein said cabinet has side walls formed by removable/openable panels and access doors.

8. The unit of claim 1 wherein the unit is a small tonnage unit having only a single condensing coil and only a single compressor and only a single outdoor fan.

9. The unit of claim 1 wherein the unit is a medium tonnage unit having two condensing coils and two compressors and only a single outdoor fan.

10. The unit of claim 1 wherein the unit is a large tonnage unit having three condensing coils and three compressors and two outdoor fans.

11. The unit of claim 1 in combination with a mushroom growing house communicating with said unit through air ducts.
